(19) United States
(12) Patent Application Publication
(10) Pub. No.: US 2023/0341593 A1
(43) Pub. Date: Oct. 26, 2023

(54) LIGHT DEVICE

(71) Applicant: SUMITOMO ELECTRIC INDUSTRIES, LTD., Osaka (JP)

(72) Inventors: Manabu SHIOZAKI, Osaka (JP); Yasutaka MIZUNO, Osaka (JP); Tomoya SAEKI, Osaka (JP); Katsumi UESAKA, Osaka (JP)

(21) Appl. No.: 18/305,414

(22) Filed: Apr. 24, 2023

(30) Foreign Application Priority Data
Apr. 25, 2022 (JP) 2022-071867
Apr. 21, 2023 (JP) 2023-069967

(51) Int. Cl. G02B 3/02

(52) U.S. Cl. CPC G02B 3/02

(57) ABSTRACT

A light device according to one embodiment includes a light source and an optical lens having an incidence plane extending in both a first axis and a second axis intersecting the first axis and an emission plane extending in both the first axis and the second axis. The optical lens converts incident light emitted from the light source and incident on the incidence plane into parallel light and emits the parallel light from the emission plane, and the incidence plane has a convex portion provided in a first direction in which the first axis extends and a concave portion provided in a second direction in which the second axis extends.

### TECHNICAL FIELD

The present disclosure relates to a light device.

### BACKGROUND

Japanese Unexamined Patent Publication No. H8-29726 discloses a beam shaping optical system that converts a light flux having an elliptical cross section into a parallel light flux having a circular cross section. The beam shaping optical system includes a collimator lens and a shaping lens. The shaping lens has a concave incidence plane and a convex emission plane. At least one of the incidence plane and the emission plane has a substantially non-circular transverse shape in an XZ plane.

Japanese Unexamined Patent Publication No. H11-39705 discloses an optical pickup device. The optical pickup device includes a light source, a coupling lens, a polarizing beam splitter, a phase shifter, a polarizing prism, an objective lens, a low-capacity optical disk, and a large-capacity optical disk. A light flux emitted from the light source is divergent. The light is emitted from the light source in an elliptical shape. That is, a divergence angle of the light flux of the light is maximum in a y direction and minimum in an x direction. The coupling lens is an anamorphic lens that has different optical functions in the two x and y directions. The coupling lens collimates an incident divergent light flux in the y direction into a parallel light flux with a light flux diameter Dy. In addition, the coupling lens expands and collimates the incident divergent light flux in the x direction into a parallel light flux with a light flux diameter Dx. The coupling lens beam-shapes the divergent light flux from the light source by allowing the light flux diameter Dx approximately to be equal to the light flux diameter Dy.

Japanese Unexamined Patent Publication No. S61-240220 discloses a light beam shaping method of a semiconductor laser. An emitted light beam emitted from the semiconductor laser passes through a collimator lens and two prisms of which positions are adjustable. In the light beam shaping method, an elliptical light beam after collimation of the light beam emitted from the semiconductor laser is shaped into a perfect circle by adjusting arrangement positions of two prisms.

The optical lens described above is used as an optical system for shaping an elliptical beam into circular collimated light. By the way, realization of highly efficient coupling using a collimated beam in a waveguide of a semiconductor laser with a high NA may be required. However, in case of the high NA, a loss due to aberration may increase. Therefore, in some cases, since the light coupling efficiency may decrease, it may be required to increase the light coupling efficiency.

An object of the present disclosure is to provide a light device capable of improving a light coupling efficiency.

### SUMMARY

A light device according to the present disclosure includes a light source and an optical lens having an incidence plane extending in both a first axis and a second axis intersecting the first axis and an emission plane extending in both the first axis and the second axis. The optical lens converts incident light emitted from the light source and incident on the incidence plane into parallel light and emits the parallel light from the emission plane, and the incidence plane has a convex portion provided in a first direction in which the first axis extends and a concave portion provided in a second direction in which the second axis extends.

According to the present disclosure, it is possible to increase a light coupling efficiency.

### BRIEF DESCRIPTION OF THE DRAWINGS

FIG. 1 is a diagram describing a design of an optical lens in an XZ cross section in an embodiment.

FIG. 2 is a diagram describing the design of the optical lens in a YZ cross section in the embodiment.

FIG. 3 is a perspective view illustrating an optical system including the optical lens according to the embodiment.

FIG. 4 is a perspective view illustrating the optical lens of FIG. 3.

FIG. 5 is a diagram describing the design of the optical lens in the YZ cross section according to the embodiment.

FIG. 6 is an enlarged view of the vicinity of a light source in FIG. 5.

FIG. 7 is a diagram describing the design of the optical lens in the XZ cross section according to the embodiment.

FIG. 8 is an enlarged view of the vicinity of the light source in

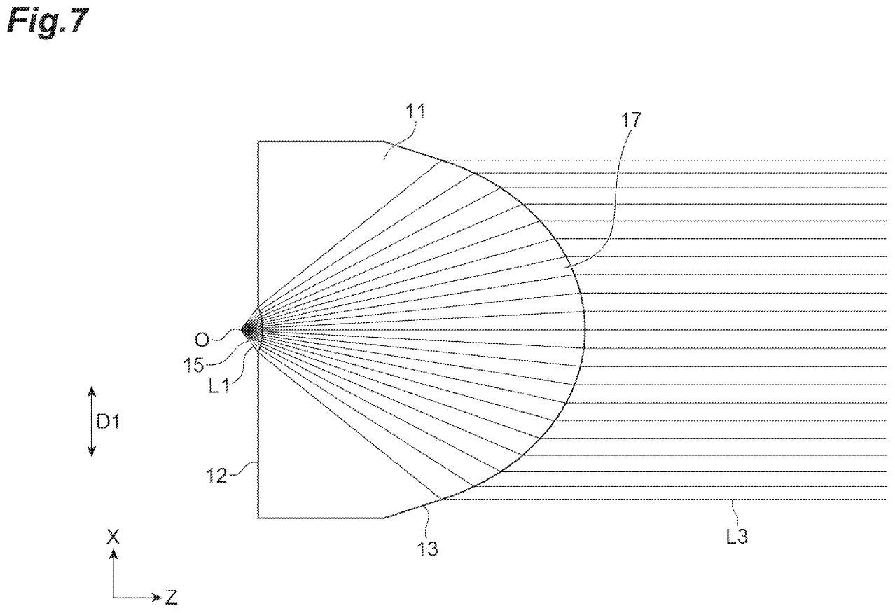

FIG. 7.

FIG. 9 is a graph illustrating an example of a relationship between a fitting error and an optical loss.

FIG. 10 is a diagram describing a design of an optical lens in the YZ cross section according to Modified Example 1.

FIG. 11 is a diagram describing the design of the optical lens in the XZ cross section according to Modified Example 1.

FIG. 12 is a diagram illustrating an optical system in the XZ cross section including an optical lens according to Modified Example 2.

FIG. 13 is a diagram illustrating the optical system in the YZ cross section including the optical lens according to Modified Example 2.

FIG. 14 is an enlarged view of a periphery of an aspherical lens of the optical system according to Modified Example 2.

### DETAILED DESCRIPTION

### Description of Embodiments of the Present Disclosure

First, contents of the embodiments of the present disclosure will be listed and described. A light device according to an embodiment includes: (1) a light source and an optical lens having an incidence plane extending in both a first axis and a second axis intersecting the first axis and an emission plane extending in both the first axis and the second axis. The optical lens converts incident light emitted from the light source and incident on the incidence plane into parallel light and emits the parallel light from the emission plane, and the incidence plane has a convex portion formed and provided when viewed from a first direction in which the first axis extends and a concave portion formed and provided when viewed from a second direction in which the second axis extends.

In the light device, in the optical lens, the incidence plane and the emission plane extend along both the first axis and the second axis, respectively. The optical lens converts the incident light emitted from the light source and incident on the incidence plane into the parallel light and emits the converted parallel light from the emission plane. The incidence plane has the convex portion and the concave portion. The convex portion is formed when viewed from the first direction in which the first axis extends, and the concave portion is formed when viewed from the second direction in which the second axis extends. By providing the incidence plane with the convex portion and the concave portion in this manner, the light coupling efficiency can be improved.

(2) In (1) above, the far-field pattern of incident light may be elliptical.

(3) In (1) or (2) above, the parallel light emitted from the emission plane of the optical lens may be a circular beam.

(4) In any one of (1) to (3) above, the emission plane of the optical lens may have a first convex portion formed and provided when viewed from the first direction and a second convex portion formed and provided when viewed from the second direction, and a curvature of the first convex portion and a curvature of the second convex portion may be different from each other. In this case, the light coupling efficiency is further improved.

(5) In any one of (1) to (4) above, the optical lens may be made of glass, silicon, or resin.

(6) In any one of (1) to (5) above, the light source may have an end face including a waveguide of the optical element. The light device may further include an aspherical lens having a flat plane that is bonded to an end face of the light source, and the optical lens may have the incidence plane which emitted light emitted from the light source is incident on. The incidence plane of the optical lens may be set to incident light. In this case, since the NA can be reduced by the aspherical lens and the optical loss due to vignetting can be suppressed, the light coupling efficiency can be improved.

### Details of Embodiment of Present Disclosure

Specific examples of optical lenses according to embodiments of the present disclosure will be described below with reference to the drawings. In the description of the drawings, the same or corresponding elements are noted by the same reference numerals, and redundant descriptions are omitted as appropriate. In addition, the drawings may be partially simplified or exaggerated for easy understanding, and the dimensional ratios and the like are not limited to those described in the drawings.

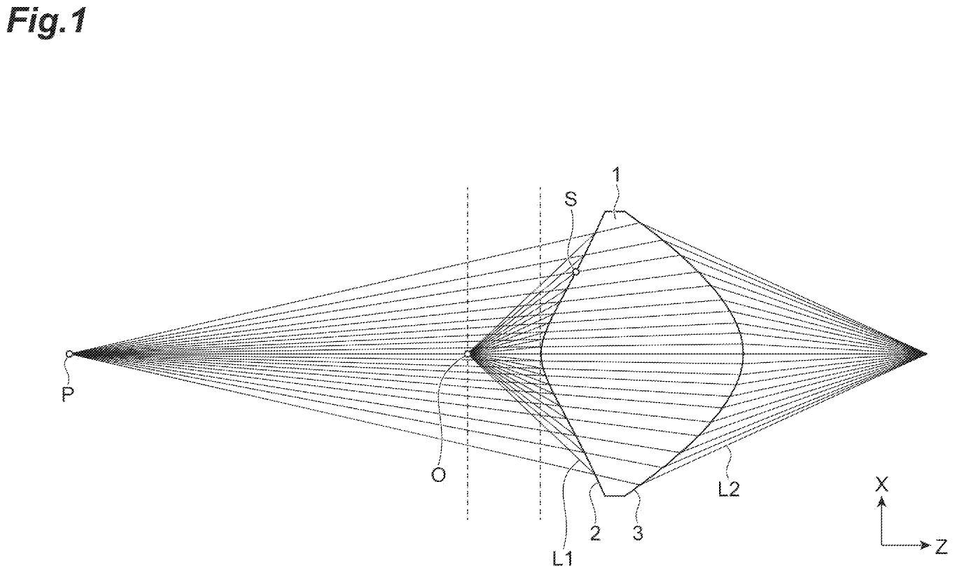

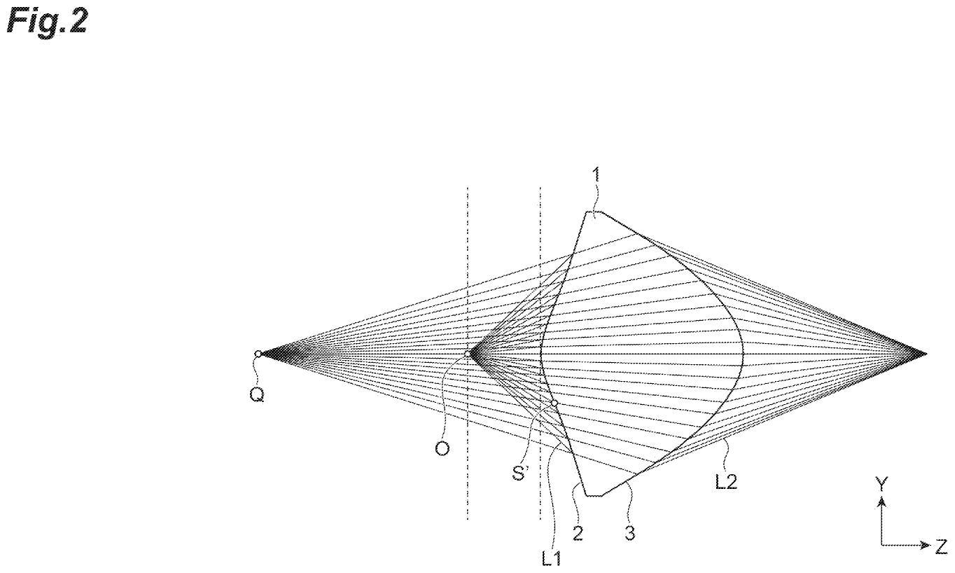

FIG. 1 illustrates the XZ cross section of the optical lens 1 as an example. FIG. 2 illustrates the YZ cross section of the optical lens 1. The XZ cross section is a cross section extending in both the X axis (first axis) and the Z axis (third axis). The YZ cross section is a cross section extending in both the Y axis (second axis) and the Z axis. As illustrated in FIGS. 1 and 2, the optical lens 1 has an incidence plane 2 which incident light L1 from a light source O is incident on and converts the incident light L1 from the incidence plane 2 into converged light L2 and an emission plane 3 that emits the converged light L2.

The incidence plane 2 is an aspherical plane. The incident light L1 from the light source O is refracted at the incidence plane 2. The aspheric plane formula of the incidence plane 2 that converges on a virtual image P on the XZ cross section and a virtual image Q on the YZ cross section is expressed as follows. In the following formula, respectively, OS denotes a distance from the light source O to an any point S on the incidence plane 2 in the XZ cross section, n denotes a refractive index of the optical lens 1, SP denotes a distance from the point S to the virtual image P, OS' denotes a distance from the light source O to an any point S′ on the incidence plane 2 in the YZ cross section, and S′Q denotes a distance from the point S′ to the virtual image Q.

(Aspheric Plane on XZ Cross Section of Incidence Plane 2)

OS−n×SP=const

(Aspheric Plane on YZ Cross Section of Incidence Plane 2)

OS′−n×S′Q=const

Each of the above formulas is obtained from the fact that an optical path length from the light source O to the virtual image P (virtual image Q) through the point S (S′) is constant in each of the XZ cross section and the YZ cross section. By placing the virtual image P and the virtual image Q at different positions, the focal length and magnification in each of the XZ cross section and the YZ cross section can be changed.

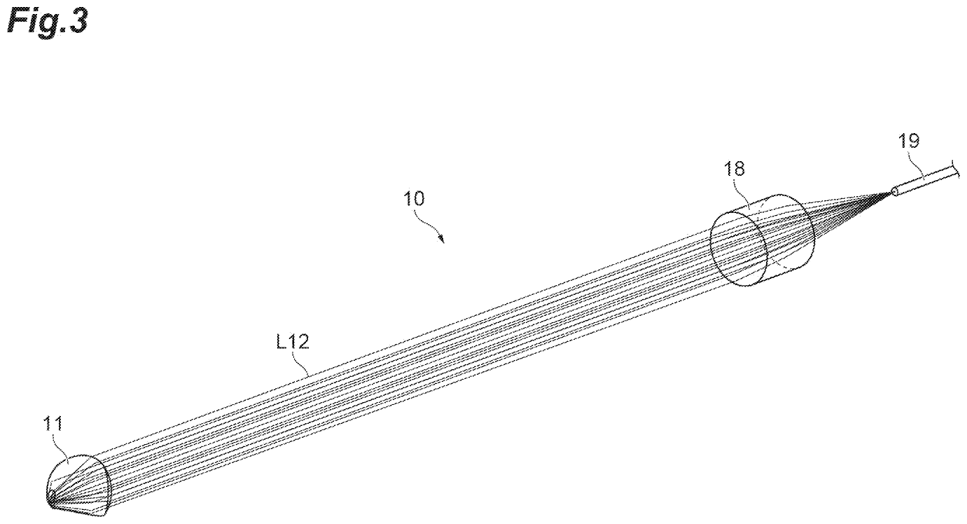

FIG. 3 is a perspective view illustrating the optical system 10, which is a light device provided with an optical lens 11 according to the embodiment. As illustrated in FIG. 3, for example, the optical system includes the optical lens 11 and a condensing lens 18. Light from, for example, a semiconductor optical waveguide is incident on the optical lens 11. The light from the semiconductor optical waveguide is an elliptical beam. As an example, a wavelength of this light from the semiconductor optical waveguide is 1.55 μm, and an MFD (mode field diameter) of the light is 2.5×1.0 μm.

The light incident on the optical lens 11 is converted by the optical lens 11 into parallel light L12. The optical lens 11 emits the parallel light L12 to the condensing lens 18. The parallel light L12 is a circular beam. The condensing lens 18 condenses the parallel light L12 from the optical lens 11 and is incident on an optical fiber 19. As an example, the optical fiber 19 is a single mode fiber and the MFD of the optical fiber 19 is 9.2 μm. In addition, the focal length of the converged light from the condensing lens 18 is 2 mm.

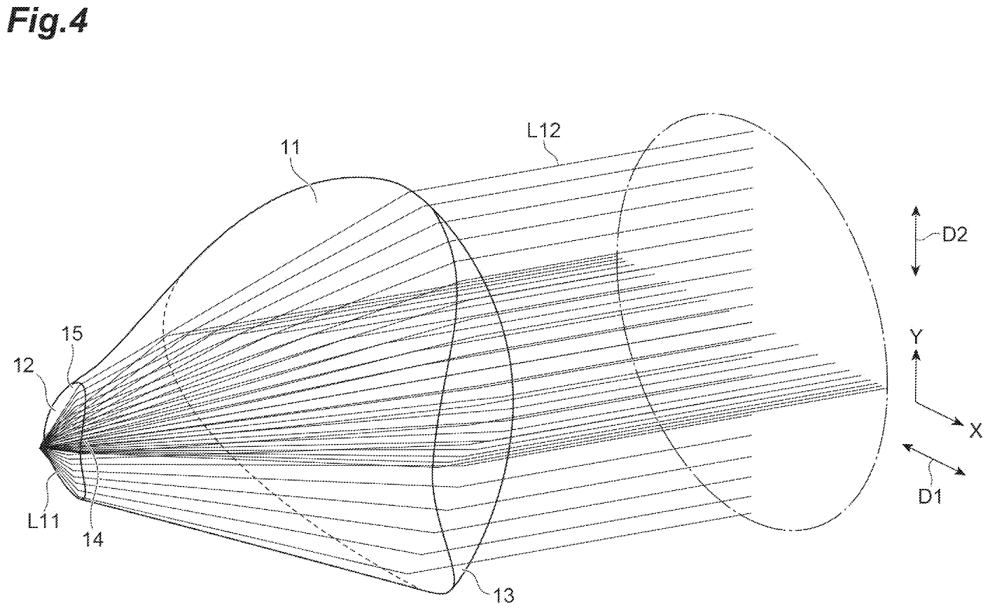

FIG. 4 is an enlarged perspective view of the optical lens 11. As illustrated in FIG. 4, the optical lens 11 has an incidence plane 12 extending in both the X-axis and the Y-axis and an emission plane 13 extending in both the X-axis and the Y-axis. The optical lens 11 converts incident light L11 that is emitted from the semiconductor optical waveguide which is a light source and incident on the incidence plane 12 into the parallel light L12 and emits the parallel light L12 from the emission plane 13.

The optical lens 11 is made of, for example, glass. The optical lens 11 is an anisotropic lens. The incidence plane 12 is an aspherical plane. The incidence plane 12 has a convex portion 14 formed when viewed from a first direction D1 in which the X axis extends and a concave portion 15 formed when viewed from a second direction D2 in which the Y axis extends. For example, the convex portion 14 is provided in a central portion of the optical lens 11 in the second direction D2, and the concave portion 15 is provided in a central portion of the optical lens 11 in the first direction D1. As an example, the convex portion 14 extends along the first direction D1. The concave portion 15 extends along the second direction D2.

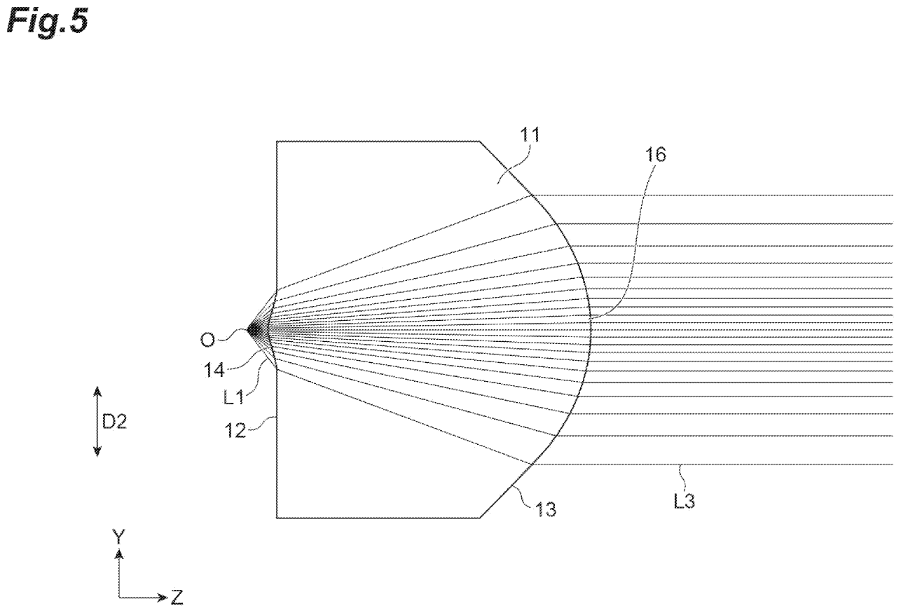

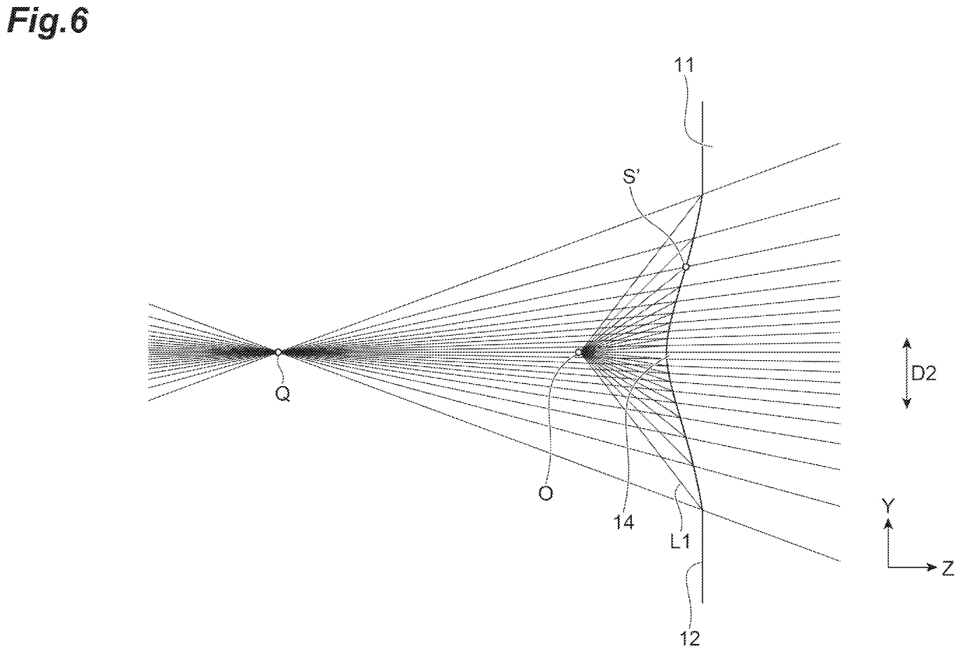

FIG. 5 is a diagram illustrating a design example of the YZ cross section of the optical lens 11. FIG. 6 is an enlarged view of the vicinity of the convex portion 14 of the optical lens 11 of FIG. 5. As illustrated in FIGS. 5 and 6, in the optical lens 11, the incident light L1 from the light source O is refracted at the incidence plane 12. The aspheric plane formula of the incidence plane 12 condensing light on the virtual image Q in the YZ cross section is expressed from a fact that an optical path length from the light source O through the point S′ to the virtual image Q is constant, as follows.

OS′−n×S′Q=const

As an example, the optical lens 11 has a value of a refractive index n of 1.78 and a numerical aperture NA of 0.8. In addition, in the YZ cross section, the optical lens 11 converts the incident light L1 with the MFD of 1.0 μm into parallel light L3 with the MFD of 430 μm. As an example, a focal length f of the optical lens 11 in the YZ cross section is 220 μm.

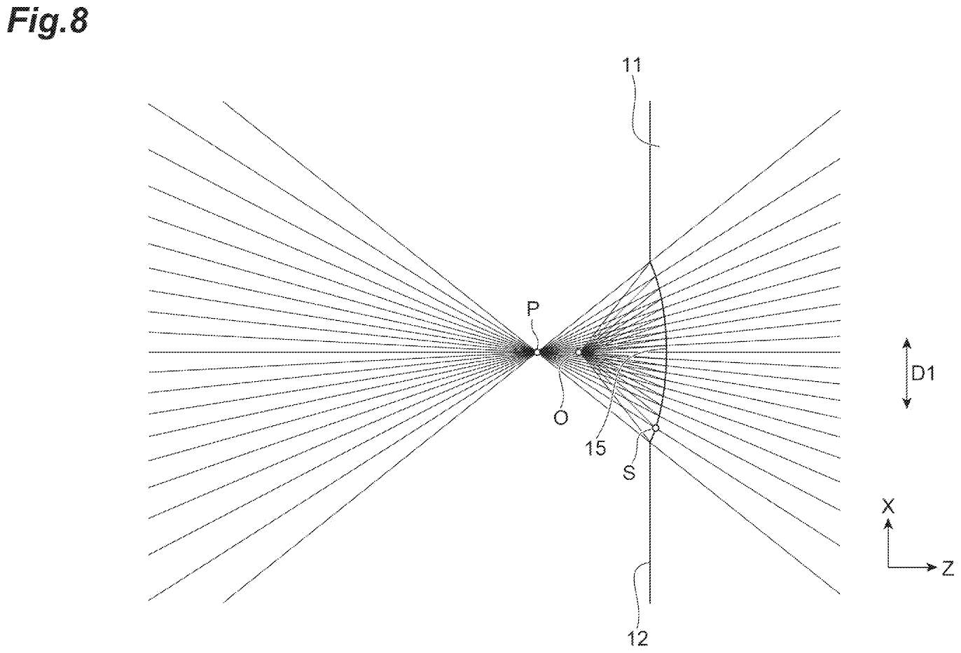

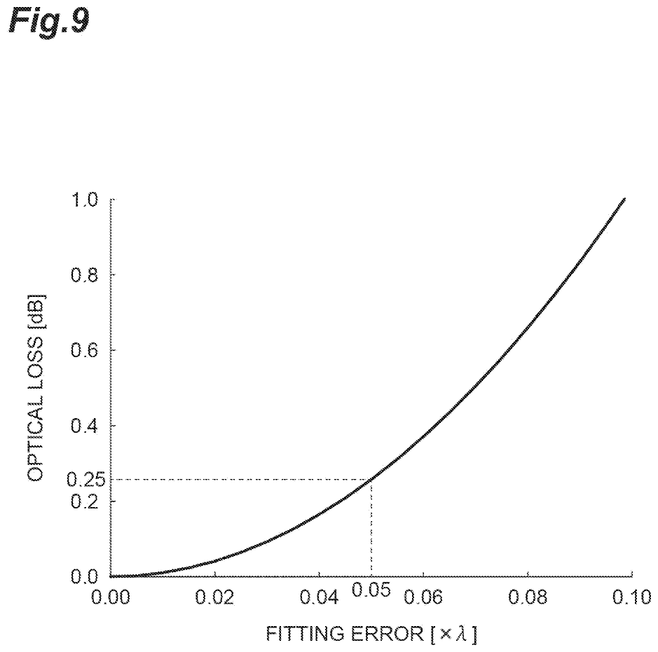

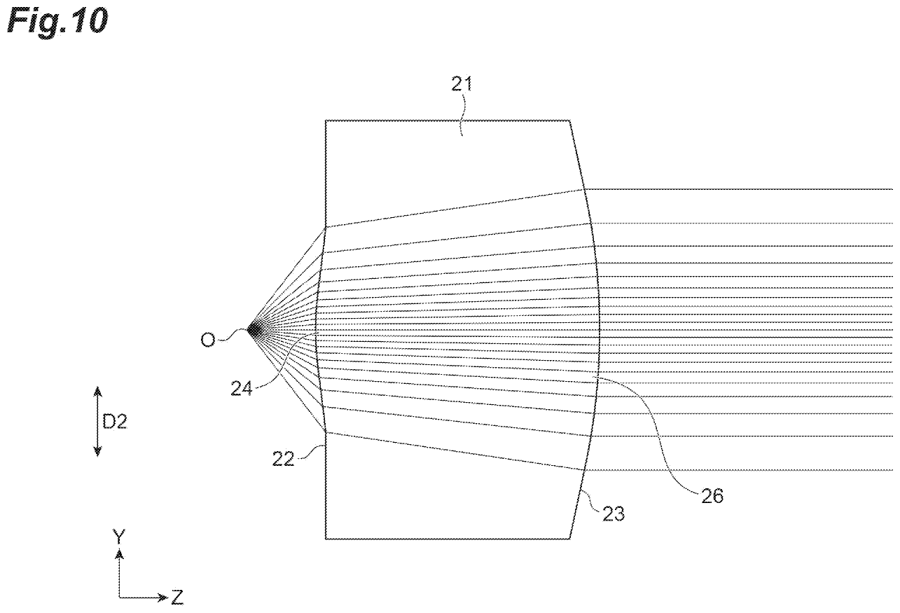

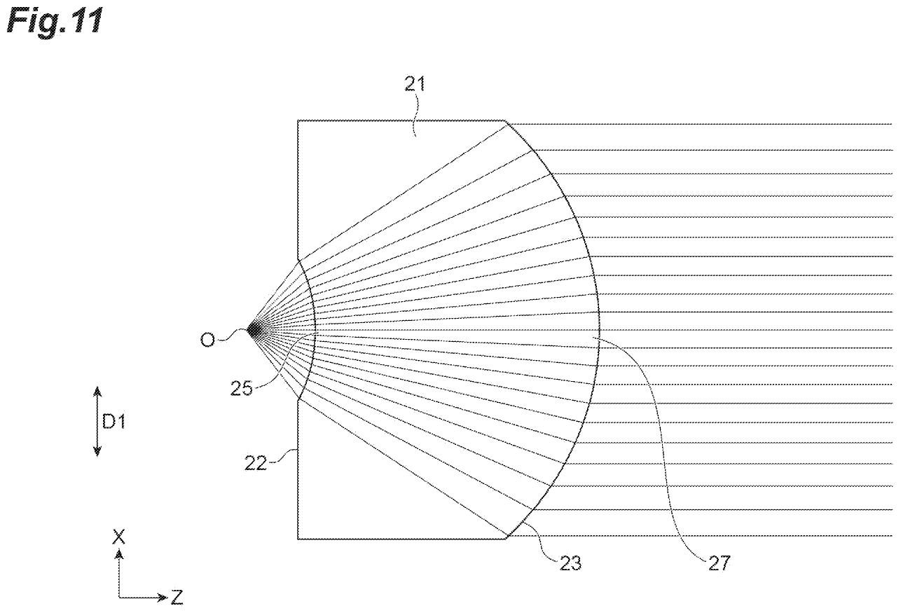

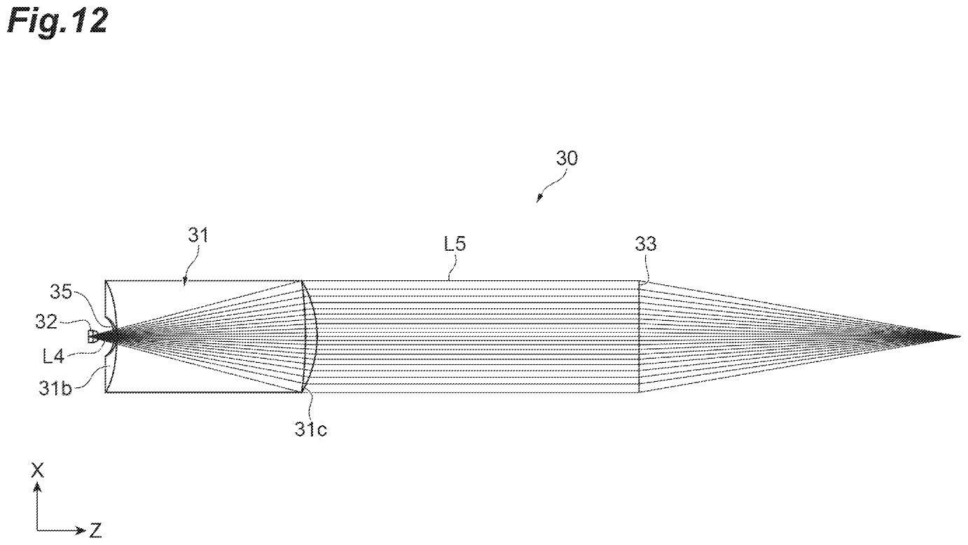

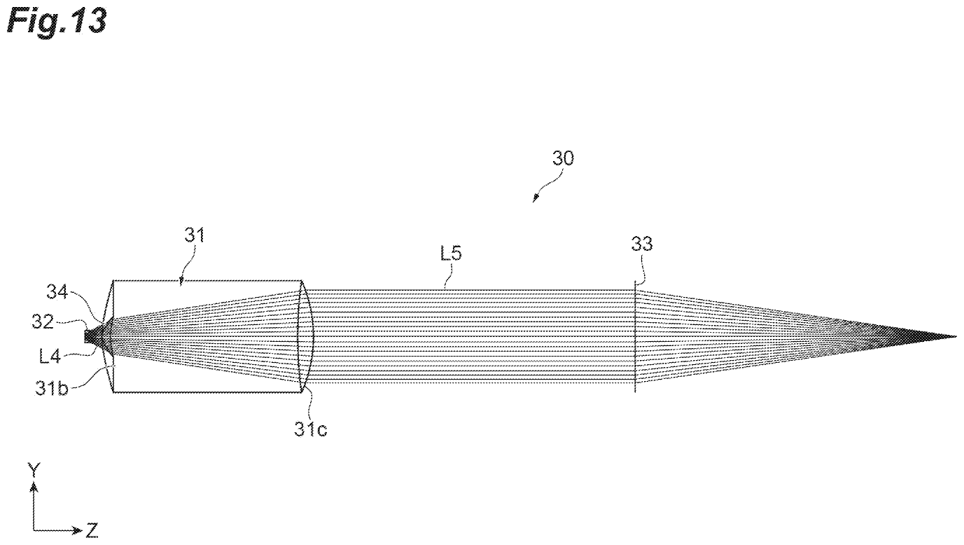

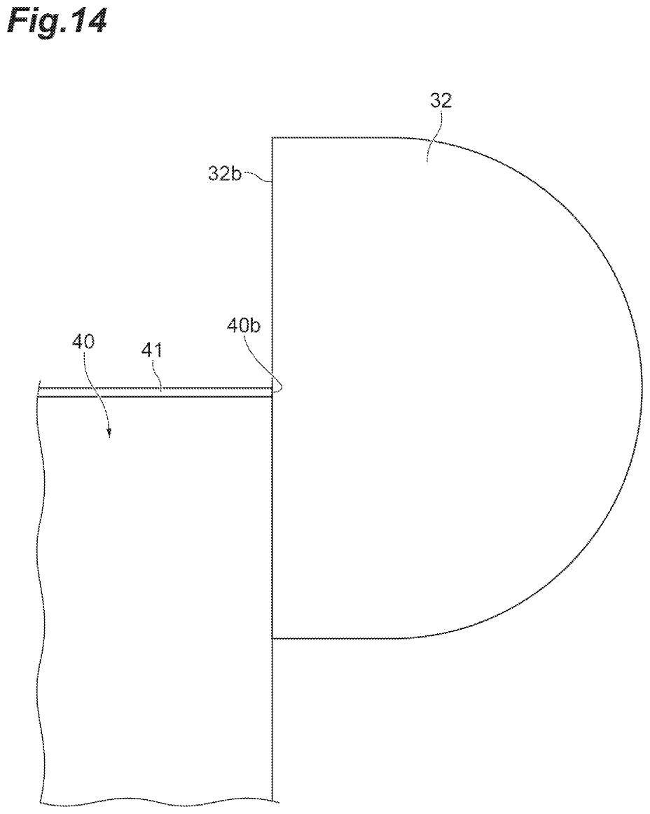

FIG. 7 is a diagram illustrating a design example of the XZ cross section of the optical lens 11. FIG. 8 is an enlarged view of the vicinity of the concave portion 15 of the optical lens 11 of FIG. 7. As illustrated in FIGS. 7 and 8, the aspheric plane formula of the incidence plane 12 condensing light on the virtual image P in the XZ cross section is expressed from a fact that an optical path length from the light source O through the point S to the virtual image P is constant, as follows.

OS−n×SP=const

In the XZ cross section, the optical lens 11 converts the incident light L1 with the MFD of 2.5 μm into the parallel light L3 with the MFD of 430 μm. Thus, the optical lens 11 converts the incident light L1, which is an elliptical beam, into the parallel light L3, which is a circular beam. As an example, the focal length f of the optical lens 11 on the XZ cross section is 550 μm.

For example, the emission plane 13 has a first convex portion 16 formed when viewed from the first direction D1 and a second convex portion 17 formed when viewed from the second direction D2. A curvature of the first convex portion 16 and a curvature of the second convex portion 17 are different from each other. For example, the curvature of the first convex portion 16 is smaller than the curvature of the second convex portion 17.

Heretofore, the design examples of the optical lens 11 have been described above. It is noted that the optical lens 11 may be fitted by extended polynomials of Formula (1) below.

$$\begin{matrix}[ Formula 1 ] & \\ z = \frac{{cr}^{2}}{1 + \sqrt{1 - ( 1 + k ) {c}^{2} {r}^{2}}} + {\sum }_{i = 1}^{n} {\sum }_{j = 1}^{i} {a}_{i - j , j} {x}^{i - j} {y}^{j} & ( 1 )\end{matrix}$$

In the above Formula (1), respectively, “c” denotes a curvature, “x” denotes a coordinate in the X-axis direction, “y” denotes a coordinate in the Y-axis direction, “z” denotes a coordinate in the Z-axis direction, “r” denotes a radial coordinate, “k” denotes a conic coefficient, and “a” denotes a coefficient of polynomial.

FIG. 9 is a graph illustrating an example of a relationship between a fitting error and an optical loss of the optical lens 11. As illustrated in FIG. 9, the optical loss increases as the fitting error increases. When the wavelength of light is λ and the fitting error is λ/20 (0.05λ), the loss becomes 0.25 dB. For example, the λ/20 is a standard of the fitting accuracy.

Next, the functions and effects of the optical lens 11 according to the embodiment will be described. In the optical lens 11, the incidence plane 12 and the emission plane 13 extend along both the X axis (first axis) and the Y axis (second axis), respectively. The optical lens 11 converts the incident light L1 emitted from the light source O and incident on the incidence plane 12 into the parallel light L3, and emits the converted parallel light L3 from the emission plane 13. The incidence plane 12 has the convex portion 14 and the concave portion 15. The convex portion 14 is formed when viewed from the first direction D1 in which the X-axis extends, and the concave portion 15 is formed when viewed from the second direction D2 in which the Y-axis extends. By providing the convex portion 14 and the concave portion 15 on the incidence plane 12 in this manner, the light coupling efficiency can be improved.

As described above, the far-field pattern of the incident light L1 incident on the incidence plane 12 may be elliptical. In addition, the parallel light L3 emitted from the emission plane 13 may be a circular beam. In this case, the elliptical beam that is divergent light from the light source O can be converted into a circular beam that is the parallel light L3 and output from the optical lens 11.

As described above, the emission plane 13 has the first convex portions 16 formed when viewed from the first direction D1 and the second convex portions 17 formed when viewed from the second direction D2, and the curvature of the first convex portion 16 and the curvature of the second convex portion 17 may be different from each other. In this case, the light coupling efficiency is further improved.

Next, an optical lens 21 according to Modified Example 1 will be described with reference to FIGS. 10 and 11. A portion of the configuration of the optical lens 21 is the same as the portion of the configuration of the optical lens 11 described above. Therefore, hereinafter, descriptions that overlap the descriptions of the optical lens 11 will be omitted as appropriate. The optical lens 21 is made of silicon. FIG. 10 is a diagram illustrating a design example of the YZ cross section of the optical lens 21. FIG. 11 is a diagram illustrating a design example of the XZ cross section of the optical lens 21.

The optical lens 21 is an anisotropic lens having an incidence plane 22 and an emission plane 23. The incidence plane 22 has a convex portion 24 formed when viewed from the first direction D1 and a concave portion 25 formed when viewed from the second direction D2. The emission plane 23 has a first convex portion 26 formed when viewed from the first direction D1 and a second convex portion 27 formed when viewed from the second direction D2, and a curvature of the first convex portion 26 is smaller than a curvature of the second convex portion 27.

A value of the refractive index n of the optical lens 21 made of silicon is higher than a value of the refractive index n of the optical lens 11 made of glass and is, for example, 3.48. Since the optical lens 21 has a higher refractive index n than the optical lens 11, a degree of freedom in a design is larger than that of the optical lens 11, and a distance from the light source O to the optical lens 21 can be increased. Therefore, the optical lens 21 can be more easily mounted.

As described above, the optical lens 21 according to Modified Example 1 is made of silicon. Since the optical lens 21 made of silicon has a higher refractive index n than the optical lens 11 made of glass, a design without forming extreme unevenness can be enabled. As a result, the influence on the optical loss when the axis shift occurs can be suppressed. On the other hand, the optical lens 11 made of glass has an advantage of stable physical properties. Furthermore, the optical lens may be made of resin. In this case, it contributes to the reduction in the cost of the optical lens.

Next, the optical system 30, which is a light device including an optical lens 31 according to Modified Example 2, will be described. FIG. 12 is a diagram illustrating the XZ cross section of the optical system 30. FIG. 13 is a diagram illustrating the YZ cross section of the optical system 30. As illustrated in FIGS. 12 and 13, the optical system 30 has an optical lens 31, an aspherical lens 32, and a condensing lens 33.

FIG. 14 is an enlarged view of the aspherical lens 32. The aspherical lens 32 is made of resin. The aspherical lens 32 can be made using, for example, 3D printing technology. The aspherical lens 32 is bonded to an end face 40b of a waveguide 41 of a laser diode chip (hereinafter referred to as “LD chip”) 40, which is an optical element having the light source.

The aspherical lens 32 is formed like a hemispherical shape. The aspherical lens 32 is an end face resin lens that is bonded to the end face of the waveguide 41 of the LD chip 40. The aspherical lens 32 has a flat plane 32b that is bonded to the end face 40b including the waveguide 41 of the LD chip 40. As an example, the magnification of the aspherical lens 32 is 2.7 times. The optical axis (central axis) of the aspherical lens 32 is, for example, provided without offset so as to be coincident with the optical axis of the waveguide 41 of the LD chip 40.

The optical lens 31 has an incidence plane 31b and an emission plane 31c, and light L4 from the aspherical lens 32 is incident on the incidence plane 31b. The optical lens 31 is an anisotropic collimating lens. As an example, the focal length f of the optical lens 31 on the XZ cross section is 1.18 mm, and the focal length f of the optical lens 31 on the YZ cross section is 0.46 mm.

The optical lens 31 is made of glass. The incidence plane 31b of the optical lens 31 has a convex portion 34 and a concave portion 35 similar to the convex portion 14 and the concave portion 15 described above. The light L4 incident on the optical lens 31 is converted by the optical lens 31 into parallel light L5. The optical lens 31 emits the parallel light L5 to the condensing lens 33. As an example, the focal length of the condensing lens 33 is 1.58 mm. The condensing lens 33 condenses the parallel light L5 from the optical lens 31 and allows the condensed light to be incident on the optical fiber. The MFD of the optical fiber is, for example, 9.6 μm.

As described above, in the optical system 30 according to Modified Example 2, the light L4 from the aspherical lens 32 having the flat plane 32b bonded to the end face 40b including the waveguide 41 of the LD chip 40, which is the optical element having the light source, is incident on the incidence plane 31b. Therefore, since the aspherical lens 32 can reduce the NA and suppress the optical loss due to vignetting, the light coupling efficiency can be improved.

The embodiments and various modifications of the optical lens according to the present disclosure have been described above. However, the invention is not limited to the embodiments or modified examples described above. That is, it is easily recognized by those skilled in the art that the present invention can be changed and modified in various ways within the scope of the claims.

What is claimed is:

1. A light device comprising:
a light source; and
an optical lens having an incidence plane extending in both a first axis and a second axis intersecting the first axis and an emission plane extending in both the first axis and the second axis,
wherein the optical lens converts incident light emitted from the light source and incident on the incidence plane into parallel light and emits the parallel light from the emission plane, and
wherein the incidence plane has a convex portion provided in a first direction in which the first axis extends and a concave portion provided in a second direction in which the second axis extends.

2. The light device according to claim 1, wherein a far-field pattern of the incident light is elliptical.

3. The light device according to claim 1, wherein the parallel light emitted from the emission plane of the optical lens is a circular beam.

4. The light device according to claim 1,
wherein the emission plane of the optical lens has a first convex portion provided in the first direction and a second convex portion provided in the second direction, and
wherein a curvature of the first convex portion and a curvature of the second convex portion are different from each other.

5. The light device according to claim 1, wherein the optical lens is made of glass, silicon or resin.

6. The light device according to claim 1,
wherein the light source has an end face including a waveguide of an optical element,
wherein the light device further comprises an aspherical lens having a flat plane being bonded to the end face of the light source; and
wherein the incident light emitted from the aspherical lens is incident on the incidence plane of the optical lens.
